(19) United States
(12) Patent Application Publication
(10) Pub. No.: US 2009/0039270 A1
(43) Pub. Date: Feb. 12, 2009

(54) LARGE-AREA ALPHA-PARTICLE DETECTOR AND METHOD FOR USE

(76) Inventors: Cyril Cabral, JR., Mahopac, NY (US); Michael S. Gordon, Yorktown Heights, NY (US); Cristina Plettner, Koln (DE); Kenneth Parker Rodbell, Sandy Hook, CT (US)

Correspondence Address: SCHMEISER, OLSEN & WATTS, 22 CENTURY HILL DR., SUITE 302, LATHAM, NY, 12110, US

(21) Appl. No.: 11/835,475

(22) Filed: Aug. 8, 2007

(51) Int. Cl. G01T 1/24

(52) U.S. Cl. 250/366; 250/370.02

(57) ABSTRACT

A method and detector for detecting particle emissions from a test sample includes positioning a detector over the test sample, wherein the detector includes a plurality of detection units, wherein each detection unit includes a first silicon detector and a barrier layer removably disposed over the first silicon detector. The method includes generating a first current signal in the silicon detector in response to receiving a first particle emitted from an atom of the test sample by the silicon detector of the first detection unit, and responsive to a recoiling daughter nuclide of the atom striking the barrier layer of the first detection unit, the recoiling daughter nuclide resulting from emission of the first particle from the atom, absorbing the recoiling daughter nuclide by the barrier layer of the first detection unit.

### FIELD OF THE INVENTION

The invention generally relates to nuclear particle detector systems.

### BACKGROUND OF THE INVENTION

The measurement of alpha particles is becoming increasingly important for the semiconductor industry as device dimensions scale down, where soft errors in computer chips may occur due to the presence of lower energy alpha particles or highly energetic cosmic radiation (e.g. neutrons). The alpha particles may deposit charge directly by ionization, and the neutrons through nuclear reactions (spallation events) into the silicon devices leading to “soft fails”. The low-energy alpha particles may originate from the chip packaging materials, impurities in component materials, or chip solders. For example, packaging materials may have trace amounts of uranium or thorium, resulting in well known decay chain products, including ²¹⁰Po from the decay of Pb having subsequent alpha particle emissions. Low-background alpha particle detection systems include gas proportional counters, where major drawbacks may include requirements for thin samples (˜1 mm), detector sensitivity to microphonic vibration due to thin metallized windows, and lack of particle energy information without the use of a Frisch Grid. There exists a need for a large-area, low background, alpha particle detector having high sensitivity which provides alpha particle energy information.

### SUMMARY OF THE INVENTION

The present invention relates to a method for detecting particle emissions from a test sample, comprising:

positioning a detector over said test sample, wherein said detector comprises a plurality of detection units, wherein each detection unit of said plurality of detection units comprises a first silicon detector and a barrier layer removably disposed over said first silicon detector;

generating a first current pulse in the silicon detector of a first detection unit of said plurality of detection units in response to receiving a first particle emitted from an atom of said test sample by said silicon detector of said first detection unit; and

responsive to a recoiling daughter nuclide of said atom striking the barrier layer of said first detection unit, said recoiling daughter nuclide resulting from emission of said first particle from said atom, absorbing said recoiling daughter nuclide by the barrier layer of said first detection unit.

The present invention relates to an alpha particle detector, comprising:

a plurality of detection units, wherein each detection unit comprises a first silicon detector and at least one barrier layer removably disposed over said first silicon detector, wherein said barrier layer is configured to allow penetration by an alpha particle through said barrier layer and substantially block penetration by a recoiling daughter nuclide through said barrier layer, said alpha particle and said recoiling daughter nuclide having been comprised by an atom.

### BRIEF DESCRIPTION OF THE DRAWINGS

The features of the invention are set forth in the appended claims. The invention itself, however, will be best understood by reference to the following detailed description of illustrative embodiments when read in conjunction with the accompanying drawings.

FIG. 1 is an illustration of an alpha particle detector comprising a plurality of detection units, in accordance with embodiments of the present invention.

FIG. 2A is an illustration of another embodiment of a barrier layer removably disposed over a silicon detector, in accordance with embodiments of the present invention.

FIG. 2B is an illustration of a silicon detector comprising a barrier layer removably disposed over the detector, in accordance with embodiments of the present invention.

FIG. 3 is an illustration of an embodiment of an alpha particle detector wherein each detection unit of the plurality of detection units may comprise a first anticoincidence detector, a second anticoincidence detector, a first silicon detector, and at least one barrier layer removably disposed over the first silicon detector, in accordance with embodiments of the present invention.

FIG. 4 is an illustration of a detection unit, in accordance with embodiments of the present invention.

FIG. 5 is an illustration of an alpha particle detector having a plurality of detection units, wherein each of the detection units may comprise at least one barrier layer and at least one silicon detector, wherein the detector may further comprise an anticoincidence detector, in accordance with embodiments of the present invention.

FIG. 6 is an illustration of an alpha particle detector connected to an electronic system configured to receive and analyze particle-generated current signals, in accordance with embodiments of the present invention.

FIG. 7 is a flow chart illustrating a method for detecting particle emissions from a test sample, in accordance with embodiments of the present invention.

FIG. 8 is a flow chart illustrating a method for detecting particle emissions from a test sample using the detector described above for FIG. 7, in accordance with embodiments of the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as examples of embodiments. The features and advantages of the present invention are illustrated in detail in the accompanying drawings, wherein like reference numerals refer to like elements throughout the drawings. Although the drawings are intended to illustrate the present invention, the drawings are not necessarily drawn to scale.

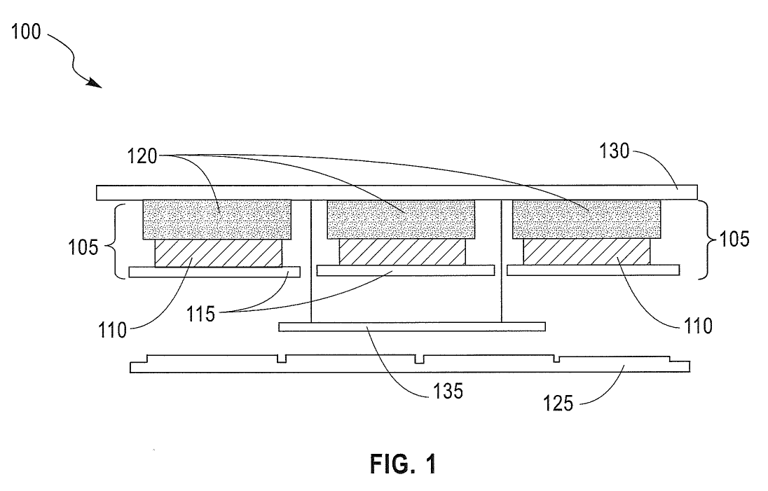

FIG. 1 is an illustration of an alpha particle detector 100 comprising a plurality of detection units 105 in an embodiment of the present invention. Each detection unit 105 may comprise a first silicon detector 110 and at least one barrier layer 115 removably disposed over the first silicon detector 110. Each detection unit may further comprise at least one anticoincidence detector 120 coupled to the first silicon detector 110. In one embodiment, the alpha particle detector 100 may further comprise a single anticoincidence detector configured to cover all of the detection units 105 of the alpha particle detector 100. The detection units 105 may be supported by an appropriate support structure. The first silicon detection 110 may be positioned between the test sample 125 and the first anticoincidence detector 120.

The anticoincidence detectors 120 may be scintillation counters, a second silicon detector, or a combination of these. The anticoincidence detector 120 may be configured to identify signals in the first silicon detector 110 which arise from high energy particles (such as alpha, beta, photon, proton, electron, cosmic rays, the like, and combinations thereof) that originate from sources other than the test sample 125, since an alpha particle from the sample 125 may be stopped within the first silicon detector 110 and be unable to reach the anticoincidence detector 120. A signal generated from a particle received by the anticoincidence detector 120 may be compared with a signal received from the first silicon detector 110. A user or a computer algorithm may compare the times of occurrence for each event to ascertain if the two events occur substantially simultaneously. If the events occur substantially simultaneously, the signal in the first silicon detector may be determined to not be from the sample 125.

The barrier layer 115 may be configured to allow penetration by an alpha particle through the barrier layer 115 and substantially block penetration by a recoiling daughter nuclide through the barrier layer 115. The barrier layer 115 may be removably disposed over the first silicon detector 110 and positioned between the first silicon detector 110 and the sample 125, thus providing a barrier for access to the first silicon detector 110 by recoiling daughter nuclides. When an alpha particle is emitted from an atom of a radioactive isotope, the residual nucleus (daughter nuclide) of the same atom recoils to conserve momentum. The recoiling nucleus may implant into an alpha particle detector having no barrier layer. Since many daughter nuclides are themselves alpha particle emitters, a daughter nuclide implanted directly on a detector may lead to an enhanced alpha particle background and thus to a reduced detector sensitivity. The present invention may include a barrier layer 115, removably disposed over each silicon detector 110, which may prevent direct implantation on the detector by recoiling daughter nuclides. The material may be thin enough, about 30 nanometers (nm) to about 2 microns, to allow alpha particles to penetrate through with minimal energy loss, while the associated recoiling daughter nuclides are substantially blocked from penetrating, by stopping the daughter nuclide within the barrier layer 115 before the daughter nuclide can penetrate through the barrier layer 115. The removable configuration of the barrier layer 115 may allow for the periodic removal and replacement of the barrier layer 115 by a user as a function of increasing detector background, to thus reduce the effects of daughter nuclides which may have become implanted in the barrier layer 115.

The barrier layer 115 may be comprised of a polymer, a nitride, an oxide, a metal or combinations thereof. In one embodiment, the polymer may include biaxially oriented polyethylene terephthalate (boPET) such as MYLAR, polyethylene, polypropylene, the like, and combinations thereof. In one embodiment, a single piece of material for the barrier layer 115 may be directly removably applied to each silicon detector 110, which then may be peeled off and replaced as may be required.

The alpha particle detector 100 may further comprise a mask 135 which may block particle emissions from a portion of the test sample 125. Such a mask 135 may allow for the detection of emitted particles from an unmasked area of the test sample 125 while excluding masked areas.

In one example, a large area (for example, about 200 millimeters (mm) to about 300 mm in diameter) segmented detector may be built directly onto a silicon wafer, and designed such that the intrinsic alpha emission is low. To accomplish this, the number of detector fabrication steps may be kept at a minimum, since each step could add various impurities which may emit alpha particles. In each fabrication step, the processed wafer may be monitored for its intrinsic alpha-particle emission. A test sample under test may be placed as close as possible (e.g. touching) to the detector, which may avoid the detection of alpha particles which may originate from the surrounding environment and contribute to the background detection levels. As such, the detector could be operated in a nitrogen, vacuum, or ambient atmosphere environment since the alpha-particles emanating from test sample 125 may not lose a significant amount of energy if the detector 100 and test sample 125 were close together (such as less than about 1 mm) or touching.

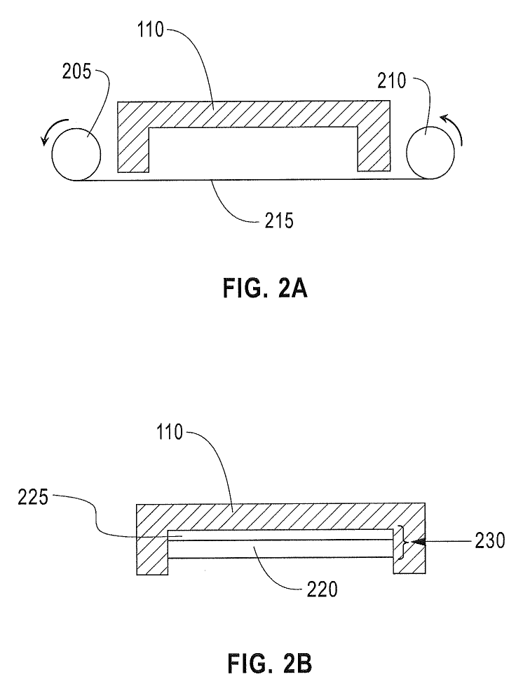

FIG. 2A is an illustration of another embodiment of a barrier layer 215 removably disposed over a silicon detector 110, wherein a roll of the polymer 205 may be configured such that when the detector background is observed to increase above a predetermined limit, the used portion of the barrier layer 215 may be slid aside (such by a take-up roll 210) while an unused portion of the barrier layer 215 can be unrolled and slid over the detector 110. As discussed above, the barrier layer 115 may be configured to be thick enough to stop recoiling daughter nuclei from implanting onto the silicon detector 110 behind the barrier layer 115. As an example, ²²⁸Th decays via alpha particle emission to ²²⁴Ra emitting an alpha particle having a kinetic energy of about 5.4 megaelectron volts (MeV). A MYLAR barrier layer 115 having a thickness of about 60 nanometers (nm) may be sufficient to substantially block a 0.1 MeV residual nucleus of ²²⁴Ra. Whereas, alpha-particles of energy about 5.4 MeV may lose only about 0.17 MeV penetrating a barrier layer 115 of such a thickness. The barrier layer 215, shown in FIG. 2A may be configured so as to be large enough to cover all of the silicon detectors 110 in an alpha particle detector 100 as described above.

FIG. 2B is an illustration of a silicon detector 110 comprising a barrier layer 230 removably disposed over the silicon detector 110, wherein the barrier layer 230 is in direct contact with the silicon detector 110. The barrier layer 230 may comprise a first layer of material 220 such as a nitride, an oxide, a metal, or combinations thereof. The first layer of material 220 may be removed by etching using a Reactive Ion Etch (RIE) process, for example. To prevent the RIE process from etching the underlying silicon of the silicon detector 110, the barrier layer 230 may further comprise an etch stop layer 225, such as a diamond-carbon layer for example, where the etch stop layer 225 may be disposed between the first layer of material 220 and the silicon detector 110. For example, a thin coating of Si₃N₄ (silicon nitride) could be applied (such as by sputtering) onto the first silicon detector 110. The range of 0.1 MeV Ra ions, for example, in such a coating may only be about 30 nm, and thus a nitride barrier layer having a thickness greater than about 30 nm may completely stop a recoiling daughter nucleus from implanting onto the underlying silicon detector. In contrast, an alpha particle of about 5.4 MeV may only lose about 6.5 kiloelectron volts (keV) penetrating such a thickness.

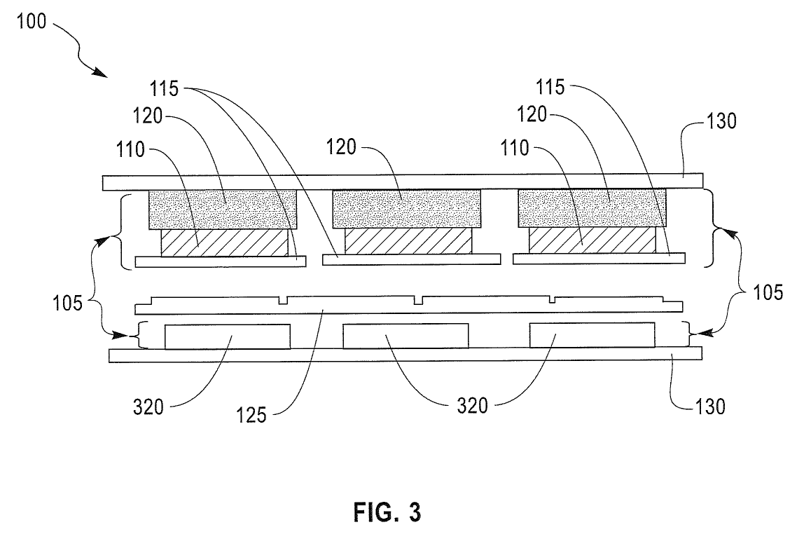

FIG. 3 is an illustration of an embodiment of an alpha particle detector 100 wherein each detection unit 105 of the plurality of detection units 105 may comprise a first anticoincidence detector 120, a second anticoincidence detector 320, a first silicon detector 110, and at least one barrier layer 115 removably disposed over the first silicon detector 110. The first silicon detector 110 may be positioned between the first anticoincidence detector 120 and the second anticoincidence detector 320 as to allow the insertion of a test sample 125 between the first silicon detector 110 and the second anticoincidence detector 320. The at least one barrier layer 115 may be positioned between the first silicon detector 110 and the test sample 125. The first anticoincidence detector 120 and the second anticoincidence detector 320 may be configured so as to intercept an energetic (high energy) particle other than those emitted from the test sample 125. A high energy particle, such as a neutron, may leave a signal in both the first anticoincidence detector 120 and the second anticoincidence detector 320, as well as the first silicon detector 110. As described above, a comparison between event times for a current signal from one of the anticoincidence detectors (120, 320) for a given detection unit 105 may allow a user to determine if a particle originated from a source other than the test sample 125 or from the test sample 125 itself. For example, if there were a coincidence between either or both anticoincidence detectors (120, 320) and the given detection unit 105, then the event recorded by the given detection unit 105 may be rejected as not originating from the sample 125.

The anticoincidence detectors (such as 120 in FIG. 1 and 320 of FIG. 3, for example) may each independently be a scintillation counter, a second silicon detector, or a combination of these. The scintillation counter may be a liquid scintillation counter, a plastic scintillation counter, or a combination of these, where the scintillation counter may be coupled to at least one photomultiplier tube, at least one photodiode, or a combination of these.

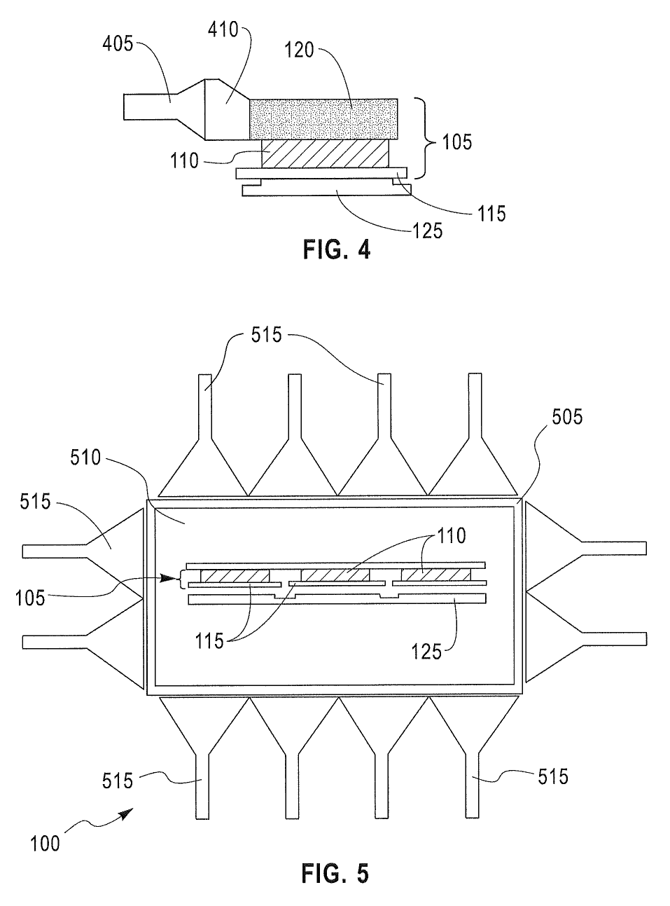

FIG. 4 is an illustration of a detection unit 115 in an embodiment of the present invention, wherein the detection unit comprises a first silicon detector 110, at least one barrier layer 115 removably disposed over the first silicon detector, and a first anticoincidence detector 120, wherein the first anticoincidence detector 120 may be a scintillation counter coupled to at least one photodetector 405 (such as a photomultiplier tube, a photodiode, etc.) via a light pipe or other similar device 410 for transmitting light from the first anticoincidence detector 120 to the photodetector 405.

The test sample 125 may be in direct contact with the detection unit 105 or a gap may be present between the test sample 125 and the detection unit 105. When the detection unit 105 is placed in close proximity to the test sample 125 (such as in direct contact), the detection unit 105 may be operated at about atmospheric pressure, as the energy loss in the thin layer of gas (such as air, argon, nitrogen, etc) between the test sample 125 and the detection unit 105 may be relatively low (i.e. may be of the order of a few keV, compared to the MeV energy of emitted alpha particles). The gap between the test sample and the detection unit 105 may be a vacuum or partial vacuum, such as when the entire sample and detector are placed under vacuum or partial vacuum for example.

FIG. 5 is an illustration of an embodiment of an alpha particle detector 100 having a plurality of detection units 105, wherein each of the detection units 105 may comprise at least one barrier layer 115 and at least one silicon detector 110, wherein the detector may further comprise an anticoincidence detector, wherein the anticoincidence detector may be a liquid scintillation counter 505 filled with a liquid scintillator 510, wherein the detection units 105 may be located inside the interior of the liquid scintillation counter 505. The test sample to be measured may be placed adjacent to the detection units 105 inside the liquid scintillation counter 505, which may detect high energy particles emitted from sources other than the test sample 125, such as from environmental gamma particle (e.g. ⁴⁰K) or cosmic neutrons. A user or electronic rejection algorithm may be used to determine which particles detected by a silicon detector 110 originated from the test sample 125 and may discard signals other than those originating directly from the test sample 125. The liquid scintillation counter 505 may produce a signal whenever an energetic muon or hadron (for example) may undergo an interaction with the scintillation liquid 510, which may be detected by a plurality of photodetectors 515 (such as photodiodes, photomultiplier tubes, etc). The detection time of a high energy particle in the liquid scintillation counter 505 may be used to trigger an anticoincidence window with the silicon detector 110, during which a substantially simultaneous signal generated in a silicon detector 110 may be rejected, thus rejecting signals generated by high energy particles which generate a signal in both the liquid scintillator 510 and the silicon detector 110. Alpha particles emitted from the sample 125 may only produce a signal in the silicon detector 110. The efficiency of the liquid scintillation counter 505 may be designed as close as possible to 100%.

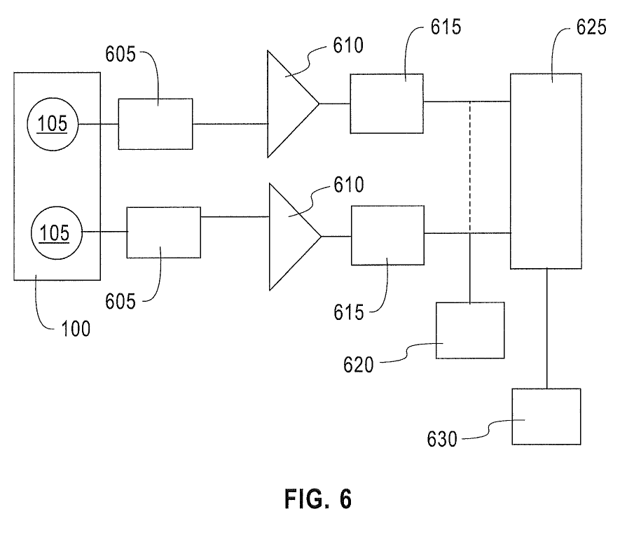

FIG. 6 is an illustration of an alpha particle detector 100 as described above connected to an electronic system configured to receive and analyze alpha-particle-generated current signals. Each detection unit 105 in the detector system 100 may be connected to appropriate power (bias) sources 605 and preamplifiers 610. The preamplifiers 610 may be connected to spectroscopy amplifiers 615 which may be connected to an analog-to-digital converter 625 connected to a computer 630. A multichannel analyzer 620 may be connected to the spectroscopy amplifiers 615 and configured to receive and analyze signals emitted from the spectroscopy amplifiers 615. A signal generated by a particle striking a silicon detector of a detection unit 105 in the detector 100 may generate an electrical current signal in the silicon detector of the detection unit 105, which may be transmitted to the computer through the electrical system described above. An algorithm in the computer or user may analyze the signal and determine the energy of the particle based on the signal received (such as the signal amplitude after appropriate amplification in the spectroscopy amplifier 615 and energy calibration, for example). The algorithm or a user may determine if the energy of the particle is above a predetermine noise tolerance level and if so accept it as a valid signal of the test sample. Those skilled in the art will recognize how to determine particle energy based on such a signal from an alpha particle detector as described here. Each detection unit of an alpha particle detector 100 as described above may be configured such that each detection unit is individually connected to the electrical system described above and thus the alpha particle detector 100 may determine the location of each event, localized to a specific detection unit.

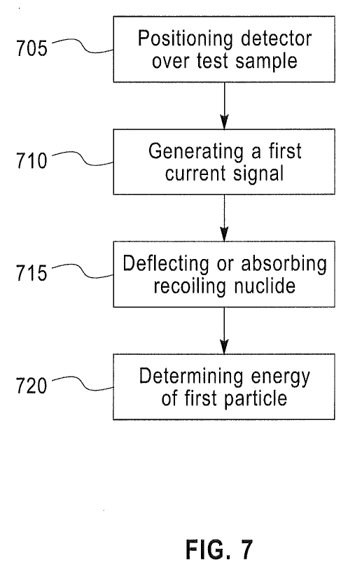

FIG. 7 is a flow chart illustrating a method for detecting particle emissions from a test sample. In step 705, a detector is positioned over the test sample. The detector may comprise a plurality of detection units, wherein each detection unit of the plurality of detection units may comprise a first silicon detector and a barrier layer removably disposed over the first silicon detector. Each detection unit may further comprise a first anticoincidence detector disposed on and substantially covering the first silicon detector. Each detection unit of the plurality of detection units may further comprise a second anticoincidence detector, wherein the test sample and the silicon detector of the first detection unit may be positioned between the first anticoincidence detector and the second anticoincidence detector of the first detection unit.

Each anticoincidence detector on the detection units may be a scintillation counter, a second silicon detector, or a combination thereof (for example half of the anticoincidence detectors may be silicon detectors and half may be scintillation counters). The scintillation counter may be a liquid scintillation counter or a plastic scintillation counter. The scintillation counter may be coupled to a plurality of photodetectors, such as photomultiplier tubes or photodiodes, for example, where the photodetectors may detect a scintillation event in the scintillation counter and intercept an energetic particle, such as an alpha particle, beta particle, gamma ray, proton, neutron, photon, electron etc.

Positioning the detector over the test sample may include positioning the detector such that detection units of the detector may be in direct contact with the test sample. Positioning the detector over the test sample may allow for a gap between the test sample and the detection units wherein the gap may be under vacuum or filled with liquid, gas (such as air, nitrogen, argon, helium or combinations of these) or combinations thereof. Positioning the detector over the test sample may include placing the test sample inside a liquid scintillation counter filled with scintillation fluid and under the detection units inside the liquid scintillation counter.

In step 710, a first current signal may be generated in the silicon detector of a first detection unit of the plurality of detection units in response to receiving a first particle emitted from an atom of the test sample by the silicon detector of the first detection unit. The particle may be a beta particle, an alpha particle, or gamma ray, the like, or combinations thereof.

In step 715, a recoiling daughter nuclide of the atom from which the particle was emitted may be absorbed by the barrier layer of the first detection unit responsive to the recoiling daughter nuclide of the atom striking the barrier layer of the first detection unit. The recoiling daughter nuclide may result from the emission of the first particle from the atom of the sample.

In step 720, the energy of the first particle may be determined based on the first current signal generated in step 710, as described above.

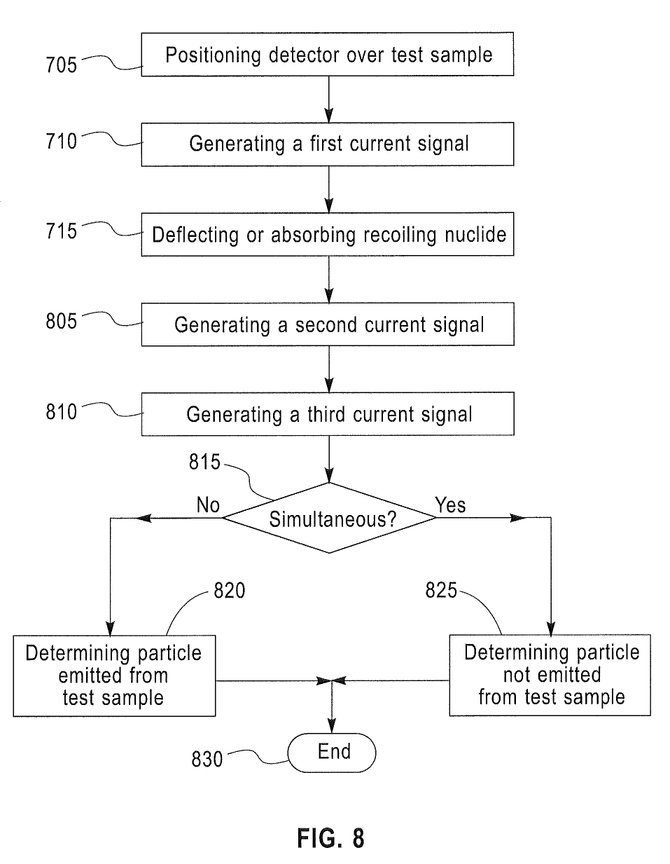

FIG. 8 is a flow chart illustrating a method for detecting particle emissions from a test sample using the alpha particle detector described above for FIG. 7.

Step 805 continues from Step 715 of FIG. 7, wherein step 805 provides for generating a second current signal in a first anticoincidence detector of a first detection unit in response to receiving a second particle by the first anticoincidence detector of the first detector.

Step 810 provides for generating a third current signal in the silicon detector of the first detection unit in response to receiving the second particle into the silicon detector of the first detection unit.

Step 815 provides for ascertaining that the second current signal and the third current signal occurred substantially simultaneously. The ascertaining may be performed by a user, by a computer algorithm, or a combination of these, by comparing time of incident for the second and third current signals.

Step 825, provides for determining that said second particle was not emitted from the test sample, based on the ascertaining of step 815. Such a determination may be made when the time of incidence for the second current signal and the third current signal are found to be substantially the same, such as within a certain time period tolerance range. High energy particles not originating from the sample may have to pass through the anticoincidence detector to reach the first silicon detector and thus generate a current signal in both substantially simultaneously. A particle originating from a sample may not reach the anticoincidence detector and thus may generate a signal in the silicon detector and may not generate a substantially simultaneous signal in the anticoincidence detector.

Step 825 provides for determining that the second particle was emitted from the test sample, based on the ascertaining of step 815. A current signal generated in the first silicon detector which has a time of event which is not the same as any other current signal in the first anticoincidence detector may originate from the test sample. The process ends at step 830.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed:

1. A method for detecting particle emissions from a test sample, comprising:
positioning a detector over said test sample, wherein said detector comprises a plurality of detection units, wherein each detection unit of said plurality of detection units comprises a first silicon detector and a barrier layer disposed over said first silicon detector
generating a first current signal in the silicon detector of a first detection unit of said plurality of detection units in response to receiving a first particle emitted from an atom of said test sample by said silicon detector of said first detection unit; and
responsive to a recoiling daughter nuclide of said atom striking the barrier layer of said first detection unit, said recoiling daughter nuclide resulting from emission of said first particle from said atom, absorbing said recoiling daughter nuclide by the barrier layer of said first detection unit.

2. The method of claim 1, further comprising:
determining an energy of said first particle from said first current signal

3. The method of claim 1, wherein each detection unit of said plurality of detection units further comprises a first anticoincidence detector disposed on and substantially covering said first silicon detector, said method further comprising:
generating a second current signal in the first anticoincidence detector of said first detection unit in response to receiving a second particle by said first anticoincidence detector of said first detector;
generating a third current signal in the silicon detector of said first detection unit in response to receiving said second particle into said silicon detector of said first detection unit; ascertaining that said second current signal and said third current signal occurred substantially simultaneously; and
determining that said second particle was not emitted from said test sample, based on said ascertaining.

4. The method of claim 3, wherein said second particle is selected from the group consisting of a gamma ray, photon, a neutron, a proton, an electron, and combinations thereof.

5. The method of claim 3, wherein said each detection unit of said plurality of detection units further comprises a second anticoincidence detector, wherein said test sample and the silicon detector of said first detection unit are positioned between the first anticoincidence detector and the second anticoincidence detector of said first detection unit, said method further comprising the steps of:
generating a second current signal in the second anticoincidence detector of said first detection unit in response to receiving a second particle by said second anticoincidence detector of said first detector;
generating a third current signal in said silicon detector of said first detection unit in response to receiving said second particle into said silicon detector of said first detection unit; ascertaining that said second current signal and said third current signal occurred substantially simultaneously; and
determining that said second particle was not emitted from said sample, based on said ascertaining.

6. The method of claim 3, wherein said first anticoincidence detector is selected from the group consisting of a scintillation counter, a second silicon detector, and a combination thereof.

7. The method of claim 6, wherein said scintillation counter is a plastic scintillation counter or a liquid scintillation counter, and wherein said scintillation counter is coupled to a plurality of photomultiplier tubes.

8. The method of claim 1, wherein said barrier layer is removably disposed over said first silicon detector, said barrier layer comprising a material selected from the group consisting of polymer, nitride, oxide, metal, and combinations thereof.

9. The method of claim 8, wherein said barrier layer has a thickness in a range from about 30 nanometers to about 2 microns.

10. The method of claim 8, wherein said barrier layer is a silicon nitride layer.

11. The method of claim 1, wherein said barrier layer is in direct contact with said first silicon detector.

12. The method of claim 1, wherein said barrier layer is separated from said silicon detector by a gap, wherein said gap is filled with gas, vacuum, or a combination thereof.

13. An alpha particle detector, comprising:
a plurality of detection units, wherein each detection unit comprises a first silicon detector and at least one barrier layer disposed over said first silicon detector, wherein said barrier layer is configured to allow penetration by an alpha particle through said barrier layer and substantially block penetration by a recoiling daughter nuclide through said barrier layer, said alpha particle and said recoiling daughter nuclide having been comprised by an atom.

14. The alpha particle detector of claim 13, wherein each detection unit of said plurality of detection units further comprises at least one anticoincidence detector coupled to said first silicon detector, wherein said at least one anticoincidence detector is selected from the group consisting of a scintillation counter, a second silicon detector, and a combination thereof.

15. The alpha particle detector of claim 14, wherein said scintillation counter is a plastic scintillation counter or a liquid scintillation counter, wherein said scintillation counter is coupled to one selected from the group consisting of at least one photomultiplier tube, at least one photodiode, and combinations thereof.

16. The alpha particle detector of claim 14, wherein said at least one anticoincidence detector comprises a first anticoincidence detector and a second anticoincidence detector, wherein said first silicon detector is positioned between said first anticoincidence detector and said second anticoincidence detector as to allow the insertion of a test sample between said first silicon detector and said second anticoincidence detector, said first and second anticoincidence detectors configured to intercept an energetic particle other than from said test sample before said particle strikes said first silicon detector.

17. The alpha particle detector of claim 13, wherein said barrier layer is removably disposed over said first silicon detector, wherein said barrier layer is a material selected from the group consisting of polymer, nitride, oxide, a metal and combinations thereof.

18. The alpha particle detector of claim 17, wherein said polymer is biaxially oriented polyethylene terepthalate.

19. The alpha particle detector of claim 17, wherein said nitride is silicon nitride.

20. The alpha particle detector of claim 17, wherein said barrier layer has a thickness in a range from about 30 nanometers to about 2 microns.
